(19) United States
(12) Patent Application Publication
(10) Pub. No.: US 2010/0187872 A1
(43) Pub. Date: Jul. 29, 2010

(54) Bicycle seat

(76) Inventor: Susan Huang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/320,455

(22) Filed: Jan. 27, 2009

(51) Int. Cl. B62J 1/08

(52) U.S. Cl. 297/215

(57) ABSTRACT

A bicycle seat includes a substantially horizontally extending seat portion and a monolithic metallic rail is connected to an underside of the seat portion so as to be connected with the guide on the top end of the seat post. The monolithic rail includes a connection portion, a rear portion and a front portion. The rear portion includes two extension rods which are connected to the rear end of the seat portion. The front portion is connected to the front end of the seat portion. The connection portion is longitudinally and adjustably attachable to the guide on the seat post of a bicycle. The rail can be used in place of the international parallel rail system and thus convert said bicycle seat from the international parallel rail system to the I-beam system.

### FIELD OF THE INVENTION

The present invention relates to a monolithic metallic structure that allows the conversion of an international style parallel rail saddle to the I-beam rail system.

### BACKGROUND OF THE INVENTION

A conventional bicycle seat is connected to top end of a bicycle seat post and a guide is located on the top end of the seat post to secure the rail located at the underside of the bicycle seat. The international system comprises of two substantially parallel rods which are clamped by the guide which is composed of a top piece, a bottom piece (or a right piece and a left piece) and a bolt-nut piece. The rods are clamped either between the top and bottom pieces or left and right side pieces and the bolt nut piece secures either pair of pieces. The I-beam system, such as disclosed in U.S. Pat. No. 6,561,578 includes a plastic composite rail which is substantially I-shaped and two plates on the top end of the seat post anchor the I-shaped rail. The seat can be adjusted in the longitudinal direction of the seat.

The two systems for securing the bicycle seat are different in structure and method of attaching to the seat so that the saddle maker must chose one of the two systems when designing the saddle according the type of guide that is to be used on the bicycle. This restricts and limits the saddle manufacturers to costly dedicated tooling for each system.

Besides, the rail of the I-beam system is a single rail molded to the underside of the seat as a single structure and the rider usually applies his/her weight on the rear portion of the seat and the single rail cannot provide sufficient support at that portion so that the seat can crack or be broken within a short period of time. Both the I-beam and international saddle rail systems suffer from failures due to limited strength capabilities inherent in their designs.

The present invention intends to provide a metallic I-beam rail separate from the saddle bottom, which can be used instead of the international rail system so that any international rail system bicycle saddle can be converted to an I-Beam saddle at the time of saddle manufacturing. In addition, the bicycle seat of the present invention provides additional support and strength beyond the current rail systems due to its monolithic metallic structure at the rear portion of the seat so as to improve the strength shortcomings of the international and I-beam bicycle seats mentioned above.

### SUMMARY OF THE INVENTION

The present invention relates to a bicycle seat comprising a substantially horizontally extending seat portion and a metallic rail connected to an underside of the seat portion. The rail includes a front portion connected to the front end of the seat portion, a rear portion connected to the rear end of the seat portion, and a connection portion which is connected between the rear portion and the front portion. The rear portion includes two extension rods extending from the rear portion at an angle so as to provide sufficient support at the rear portion of the seat portion. The connection portion is longitudinally and adjustably attachable to a guide on a seat post of a bicycle.

A primary object of the present invention is to provide a metallic I-beam rail structure that can be inserted in any international system style bicycle seat thus converting said seat into a I-beam system bicycle seat.

Another primary object of the present invention is to provide a metallic I-beam rail of a bicycle seat wherein the rail provides increased support and strength at the front and rear portion of the seat due to its monolithic structure.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bicycle seat of the present invention;

FIG. 2 is an exploded view to show the seat portion and the rail of the present invention;

FIG. 3 is a bottom view to show the seat portion and the rail of the present invention;

FIG. 4 shows that the seat portion is connected with another type of rail, and

FIG. 5 is an exploded view to show another embodiment of the rail of the present invention.

### DETAILED DESCRIPTION OF THE PREFERRED EMBODIMENT

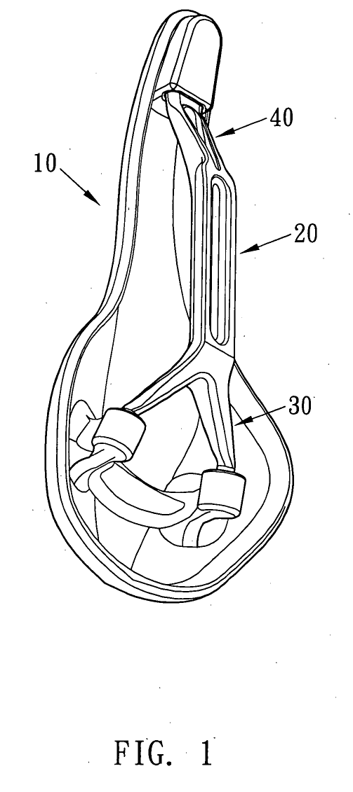

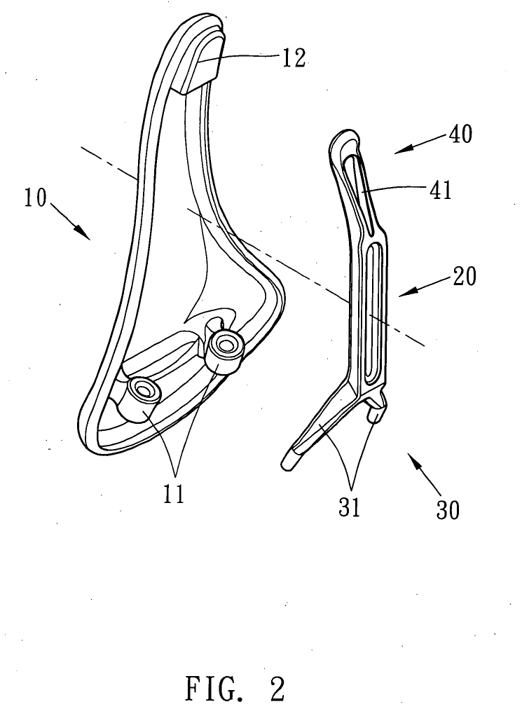

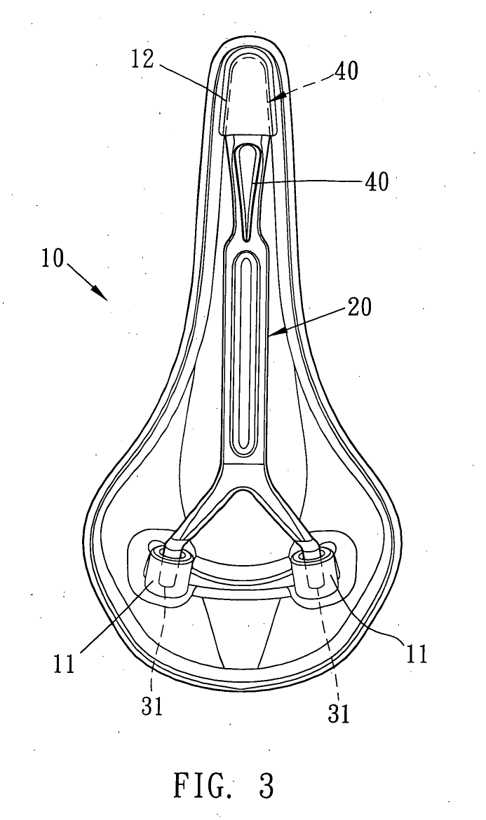

Referring to FIGS. 1 to 3, the bicycle seat includes a substantially horizontally extending seat portion 10 and a rail is connected to an underside of the seat portion 10. The rail includes a connection portion 20, a rear portion 30 and a front portion 40, wherein the connection portion 20 is a straight and elongate portion and connected between the rear portion 30 and the front portion 40. The front portion 40 and the rear portion 30 are inclined relative to the connection portion 20 and extend from two ends of the connection portion 20 at two respective angles, such that a gap is defined between the seat portion 10 and the connection portion 20. The gap is helpful for compatibility with both the I-beam system and the international system. An aperture 41 and a slot are defined through the front portion 40 and the connection portion 20 respectively so as to reduce the weight of the rail. The rear portion 30 includes two extension rods 31 extending from the rear portion 30 at an angle so as to form a fork like arrangement.

A front reception port 12 is defined in the front end of the underside of the seat portion 10 and the front portion 40 is inserted in the front reception port 12. Two rear reception ports 11 are defined in the rear end of the underside of the seat portion 10 and the two extension rods 31 of the rear portion 30 are inserted in the rear reception ports 11.

The connection portion 20 can be clamped by two plates of a guide on a top end of the bicycle seat post (both not shown) so that the connection portion 20 can be adjustable relative to the seat post.

The rail is not integrally formed with the seat portion 10 and is a separate metallic piece from the seat portion 10. The two extension rods 31 are separated at a distance so as to provide a wide area for supporting the weight at the rear portion of the seat portion 10.

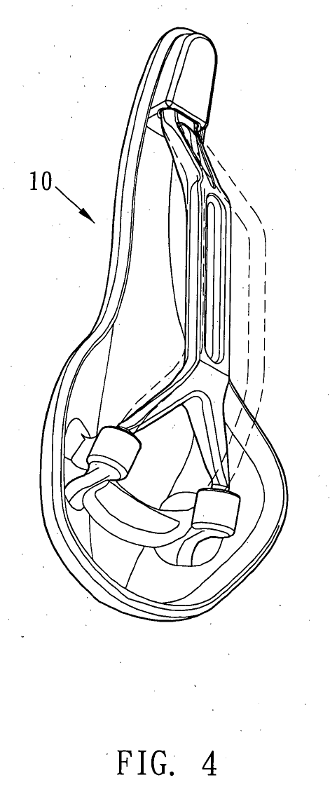

As shown in FIG. 4, because there are two rear reception ports 11 defined in the rear end of the underside of the seat portion 10, the rail can also be replaced with dual-rod type which is cooperated with the international system.

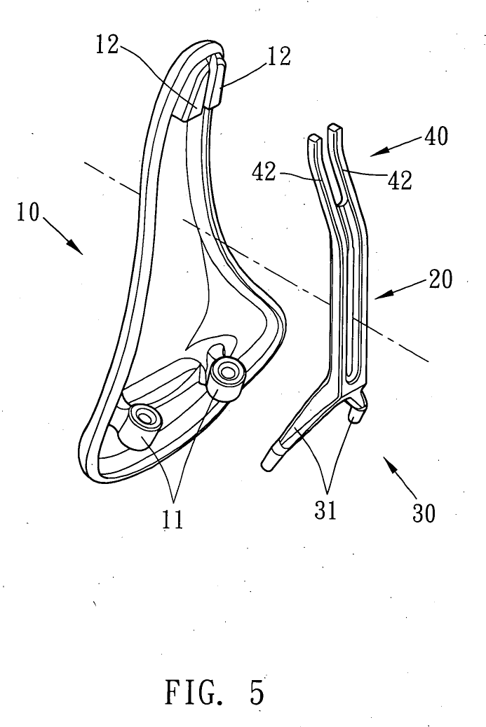

FIG. 5 shows another embodiment of the rail of the present invention, wherein the front portion 40 of the rail includes two insertions 42 separated apart from each other, and there are two front reception ports 12 defined in the front end of the underside of the seat portion 10 so as to receive the two insertions 42.

While we have shown and described the embodiment in accordance with the present invention, it should be clear to those skilled in the art that further embodiments may be made without departing from the scope of the present invention.

What is claimed is:

1. A bicycle seat comprising:
a substantially horizontally extending seat portion, and
a metallic I-beam rail connected to an underside of the seat portion and having a connection portion, a rear portion and a front portion, the connection portion connected between the rear portion and the front portion, the rear portion including two extension rods extending from the rear portion at an angle, the two extension rods connected to a rear end of the seat portion, the front portion connected to a front end of the seat portion, the connection portion adapted to be longitudinally and adjustably attachable to a guide on a seat post of a bicycle.

2. The bicycle seat as claimed in claim 1, wherein a front reception port is defined in the front end of the underside of the seat portion and the front portion is inserted in the front reception port.

3. The bicycle seat as claimed in claim 1, wherein two rear reception ports are defined in the rear end of the underside of the seat portion and the two extension rods of the rear portion are inserted in the rear reception ports.

4. The bicycle seat as claimed in claim 1, wherein an aperture is defined through the front portion.

5. The bicycle seat as claimed in claim 1, wherein a slot is defined through the connection portion.

6. The bicycle seat as claimed in claim 1, wherein the front portion and the rear portion extend from two ends of the connection portion at two respective angles.

7. The bicycle seat as claimed in claim 1, wherein the front portion includes two insertions separated apart from each other.
